(19) United States
(12) Patent Application Publication
(10) Pub. No.: US 2017/0150003 A1
(43) Pub. Date: May 25, 2017

(54) IMAGE FORMING APPARATUS, METHOD AND STORAGE MEDIUM FOR SHARING SETTING INFORMATION

(71) Applicants: KABUSHIKI KAISHA TOSHIBA, Tokyo (JP); TOSHIBA TEC KABUSHIKI KAISHA, Tokyo (JP)

(72) Inventor: Hiroshi Odagiri, Fuji (JP)

(21) Appl. No.: 14/945,677

(22) Filed: Nov. 19, 2015

(51) Int. Cl. H04N 1/32; H04N 1/00

(52) U.S. Cl. CPC H04N 1/32523; H04N 1/00347; H04N 1/00517; H04N 1/00244; H04N 2201/0077; H04N 2201/0031

(57) ABSTRACT

According to an embodiment, an image forming apparatus belonging to a pre-defined group comprises a storage section, an interface section and a processor. The storage section stores first setting information. The interface section receives second setting information. The processor compares the first setting information with the second setting information. If the second setting information is the newer one, the processor replaces the first setting information with the second setting information to update it, and reflects it to enable the image forming apparatus to operate according to the second setting information, and controls the interface section to send the second setting information to other image forming apparatuses belonging to the group. If the first setting information is the newer one, the processor controls the interface section to send the first setting information to other image forming apparatuses belonging to the group.

### FIELD

Embodiments described herein generally relate to a technology for distributing setting information of an image forming apparatus.

### BACKGROUND

It is necessary for an image forming apparatus to execute a proper set according to use condition and operation condition.

Conventionally, a maintainer has to set the whole apparatuses at the timing when installing an image forming apparatus or at the timing when the use environment or use condition is changed.

However, if the number of the apparatuses to be set is large, it takes much time to execute a setting operation, and a mistake during the setting operation is likely to occur. If a confirmation job is also contained, it is a disadvantage to make no progress in comprehensive saving of labor.

### DESCRIPTION OF THE DRAWINGS

FIG. 1 is a diagram illustrating an example of constitution of a system containing a plurality of MFPs (Multifunction Peripheral);

FIG. 2 is a schematic diagram illustrating an example of internal constitution of a master-MFP;

FIG. 3A and FIG. 3B are schematic diagrams illustrating examples of internal constitutions of MFPs other than the master-MFP;

FIG. 4 is a diagram exemplifying setting information according to an embodiment;

FIG. 5 is a diagram exemplifying a group list according to the embodiment;

FIG. 6 is a flowchart illustrating an example of operation when the MFP is started;

FIG. 7 is a flowchart illustrating an example of operation when the MFP is in an operating state; and

FIG. 8 is a flowchart illustrating an example of operation in update processing on the setting information.

### DETAILED DESCRIPTION

According to an embodiment, an image forming apparatus belonging to a pre-defined group comprises a storage section, an interface section and a processor. The storage section stores first setting information serving as setting information of the image forming apparatus. The interface section receives second setting information serving as setting information of the image forming apparatus. The processor compares the first setting information with the second setting information. In a case where the second setting information is the newer one, the processor replaces the first setting information with the second setting information to update it, and reflects the second setting information to enable the image forming apparatus operate according to the second setting information. And then the processor controls the interface section to send the second setting information to other image forming apparatuses belonging to the group. If the first setting information is the newer one, the processor controls the interface section to send the first setting information to other image forming apparatuses belonging to the group.

Hereinafter, in the embodiment, a plurality of the image forming apparatuses classified into the same group carries out communication with each other to share the setting information. In this group, at least one image forming apparatus is selected to be a master-image forming apparatus in advance.

The image forming apparatuses in one group communicate with each other through a network. If the setting information of any apparatus in one group is updated, the updated setting information is sent to all the image forming apparatuses. The image forming apparatus receiving the updated setting information updates setting information stored therein with the received setting information and operates according to the updated setting information. In this way, the image forming apparatuses in one group always share latest setting information and operate according to the latest setting information.

If a new image forming apparatus is added into the group, the added apparatus communicates with peripheral apparatuses and receives information from the apparatus storing the latest setting information. The added image forming apparatus reflects the received setting information and operates according to the received setting information.

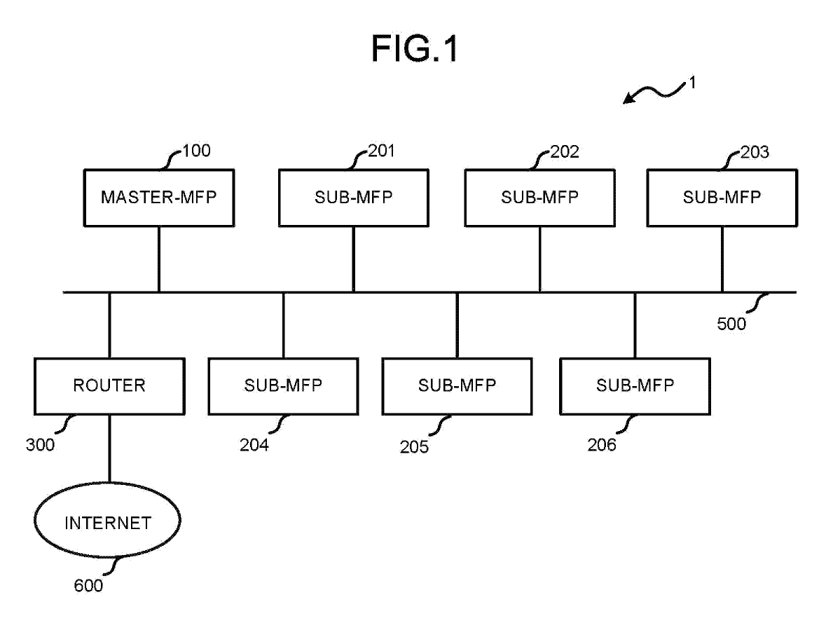

Hereinafter, an embodiment is described with reference to the accompanying drawings. FIG. 1 is a schematic diagram illustrating the constitution of an image forming system according to the embodiment. The image forming system 1 includes one or more than one MFP (Multifunction Peripheral). The MFP refers to an image forming apparatus including a copy function, a printer function, a scanner function, a FAX transmission/reception function and the like.

The image forming system 1 includes an MFP 100 and MFPs 201-206, which are connected with each other via a network 500 to transmit/receive data. Herein, the MFP 100 is referred to as a master-MFP, and the MFPs 201-206 are referred to as sub-MFPs. The master-MFP 100 is a representative MFP for managing MFPs contained in the system 1. One group is formed by the MFP 100 and the MFPs 201-206. It is determined optically at the time of designing which one of MFPs is the master-MFP. Further, in a case where one MFP is introduced and the other MFPs are introduced thereafter at any time, the one introduced initially may be the master-MFP.

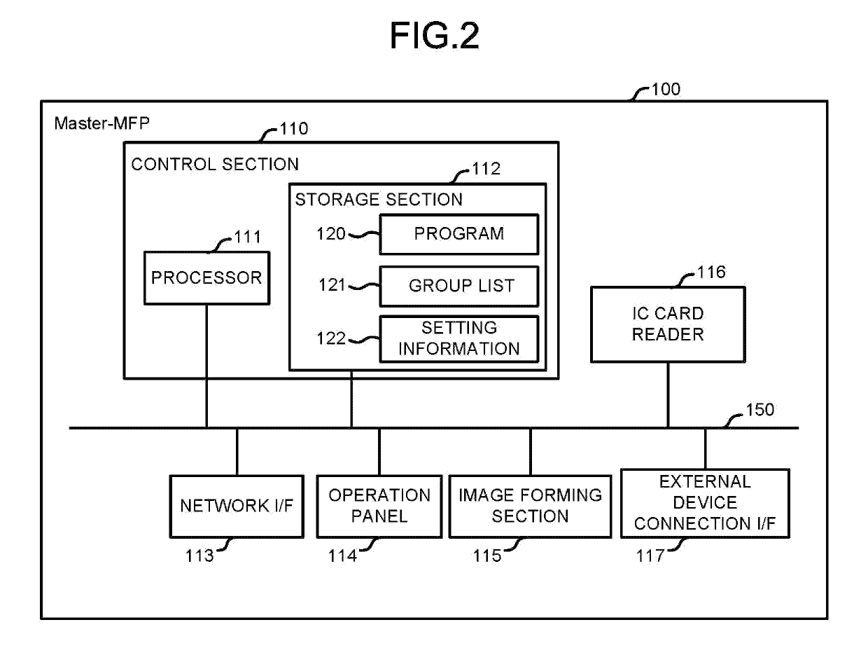

FIG. 2 is a diagram exemplifying the hardware structure inside the master-MFP 100. Each unit shown in FIG. 2 transmits/receives data via a bus line 150.

The master-MFP 100 comprises a processor 111 and a storage section 112. The processor 111 is, for example, an operating processing apparatus such as a CPU (Central Processing Unit). The processor 111 realizes each function described later by executing a program 120 stored in the storage section 112.

The storage section 112 includes a main storage device (memory) which directly inputs/outputs data from/to the processor 111 and stores data in a volatile manner. Further, the storage section 112 includes an auxiliary storage device and a ROM for storing data in a non-volatile manner. The storage section 112 stores the program 120 executed by the processor 111, a group list 121 and setting information 122. The group list 121 and the setting information 122 are described later.

It is assumed that a control section 110 is constituted by the processor 111 and the storage section 112. The control section 110 integrally controls each unit shown in FIG. 2.

The master-MFP 100 includes a network I/F (interface) 113. The network I/F 113, according to an instruction of the control section 110, receives a printing job from a personal computer and the like through the network 500 and replies a telegram of the condition status and the result of processing to the personal computer serving as the transmission source. The network I/F 113 carries out data communication with the sub-MFPs 201-206 through the network 500 to transmit/receive the setting information. The network I/F 113 can also transmit/receive data (e.g. setting information) to/from an external server though a router 300 and an internet 600.

The operation panel 114 including a touch panel display receives instruction from a user and executes notification of execution status of job and other necessary notification.

An image forming section 115 includes a photoconductive drum, a developer, a transfer unit, a fixing unit and the like. The image forming section 115 causes these units to operate to form an image designated by the user on a sheet.

An IC (Integrated Circuit) card reader 116 reads an IC card hold by the user. The IC card reader 116 reads personal information such as a user ID and a password recorded in the IC card. The control section 110 or an external authentication server carries out authentication processing based on the reading information. If the authentication is proper, the user can use the master-MFP 100.

An external device connection I/F 117 includes a USB connection terminal to transmit/receive data to/from an external storage device, for example, a USB memory and the like.

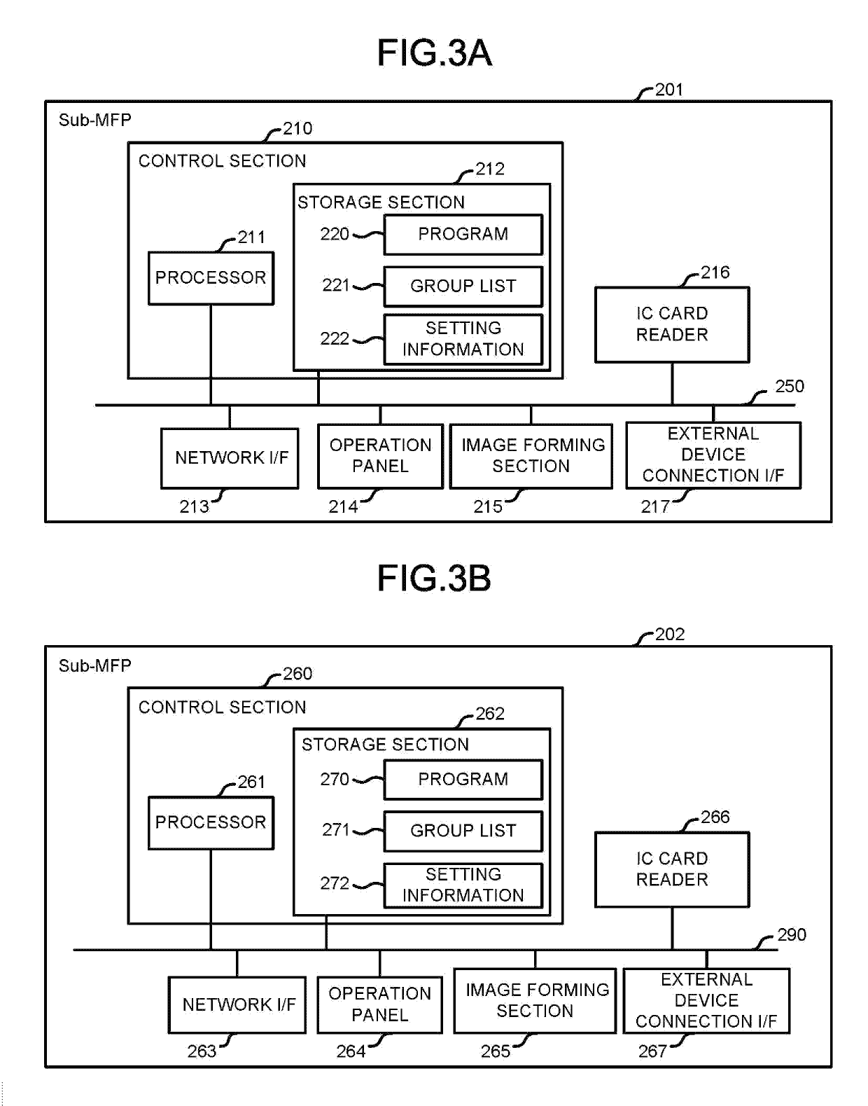

FIG. 3A is a diagram exemplifying hardware structure inside the sub-MFP 201. FIG. 3B is a diagram exemplifying hardware structure inside the sub-MFP 202. Herein, the sub-MFPs 201 and 202 are shown, and the sub-MFPs 203-206 have the same constitution with the sub-MFPs 201 and 202.

The sub-MFP 201 includes a processor 211, a storage section 212, a network I/F 213, an operation panel 214, an image forming section 215, an IC card reader 216 and an external device connection I/F 217. These units carry out data transmission/reception via a bus line 250. Each unit described above has equal function with each unit shown in FIG. 2. A control section 210 is constituted by the processor 211 and the storage section 212.

The storage section 212 stores a program 220 executed by the processor 211, a group list 221 and setting information 222. Furthermore, the setting information 222 may be set by default or may not be set when an MFP is initially introduced.

The sub-MFP 202 shown in FIG. 3B has the same constitution with the sub-MFP 201 shown in FIG. 3A, and therefore repeated description is omitted. In the present embodiment, the units inside the sub-MFP 202 are described with the marks shown in FIG. 3B.

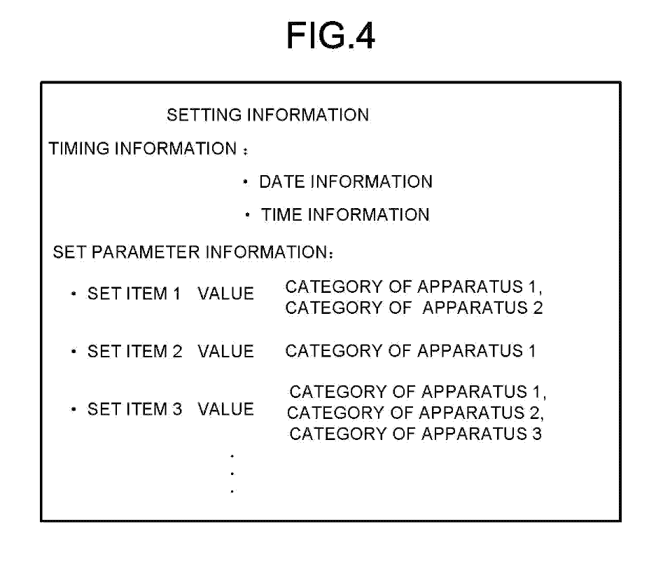

FIG. 4 is a diagram illustrating an example of data structure of setting information of the embodiment. The setting information 122, 222 and 272 are exemplified. The setting information contains timing information and the setting parameter information. The timing information includes data information represented by year, month and day and time information represented by hour, minute and second. The value shown in the timing information becomes data or time when the setting information is generated.

The setting parameter information may be, for example, setting information of an image forming system (software system) such as adjustment value of color balance, or may be setting information of hardware system such as conveyance speed of the sheet or setting temperature of the fixing unit. The setting parameter information corresponds to a set item and a set value of the set item. As there is a set item unique to one category of device, for example, a color image cannot be formed according to the category of the device, an applicable name of the category of device also corresponds to the item.

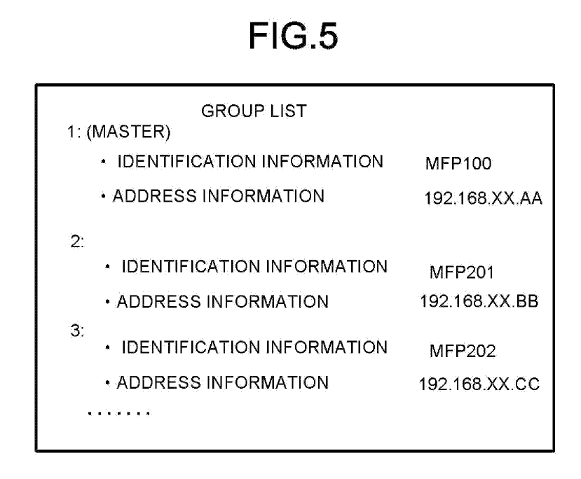

FIG. 5 is a diagram illustrating an example of data structure of the group list of the embodiment. The group lists 121, 221 and 271 shown in FIG. 2 and FIG. 3 are exemplified. The group list is a list file for defining which MFP belongs to the group. The group list is information for mutually identifying the MFP 100 and the MFPs 201-206 serving as members constituting the group.

The group list is a list in which one record is generated by associating the sequence number for identifying data such as ‘1’, ‘2’ and the like in the list with the identification information such as name for determining a device and a value of IP address assigned to the device. It is assumed that the master-MFP is attached with a mark (referred to as a character string of ‘master’ in present embodiment) for identifying that it is a master-MFP. In addition, a rule may be made that the MFP of which the sequence number is ‘1’ is the master-MFP.

If an MFP is added, then the group list adds the record of the MFP. The addition is carried out in such a manner that a maintainer manually rewrites the group list file with respect to the group list 121 in the master-MFP 100. Further, when a new group list file is acquired from an external device, the addition is carried out by overwriting and updating the group list. If an MFP is excluded from the group, the maintainer also rewrites the group list 121 in the master-MFP 100 to delete the MFP. That is, the group list 121 in the master-MFP 100 becomes the latest list information. The sub-MFPs 201-206 receive the latest group list 121 as necessary to update the group list thereof.

Further, the data in the group list may be only the information for determining the MFP to be in a communicable state. For example, the information may be only an IP address, only a host name, or only MAC address in a case of belonging to the same segment.

Hereinafter, the operation of the embodiment is described with reference to the flowcharts. Each step shown in the flowcharts is carried out through arithmetically executing programs stored in the storage sections by the processors shown in the FIG. 2, FIG. 3A and FIG. 3B.

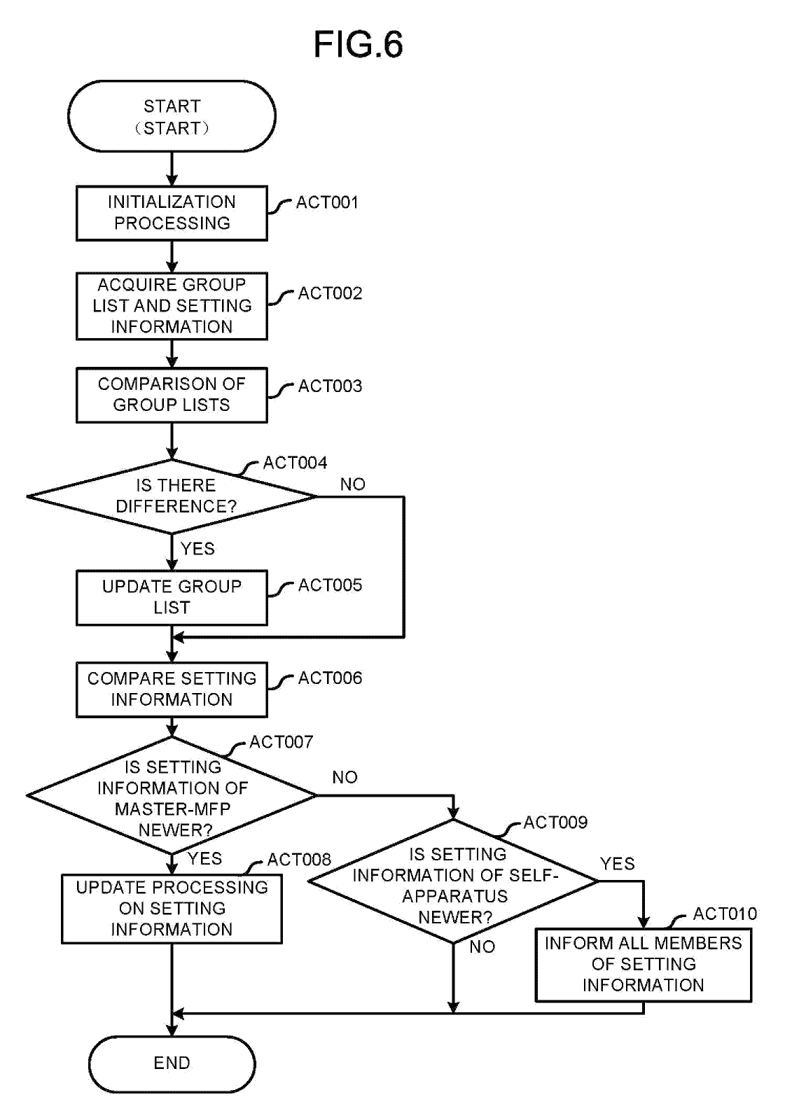

FIG. 6 is a flowchart illustrating an example of operation at the time of starting or restarting the sub-MFP 201. Herein, the example is described as the operation of the sub-MFP 201, and the sub-MFPs 202-206 also execute the same operation. There are different steps, that is, different processing, which are described as necessary, between the master-MFP 100 and the sub-MFPs 201-206. The reason why the start operation or the restart operation is assumed as a trigger for the operation of the FIG. 6 is that the start operation or the restart operation accompanies the reflection operation of the setting information.

After the power source of the sub-MFP 201 is turned on or after restarting the sub-MFP 201, the control section 210 executes initialization processing (ACT 001). The initialization processing serving as the operation for making the sub-MFP 201 in an operating state is executed from previous time. The control section 210 causes the network I/F 213 to operate to receive the group list 121 (a second group list) and the setting information 122 (second setting information) from the master-MFP 100 (ACT 002). The control section 210 temporarily stores the received group list 121 and the setting information 122 in the storage section 212. The control section 210 compares the received group list 121 with the group list 221 (a first group list) stored therein (ACT 003). If there is a difference between the group list 121 and the group list 221 (Yes in ACT 004), the control section 210 replaces the group list 221 stored therein with the received group list 121 to update it (ACT 005). If the sub-MFP 201 is newly introduced, as there is no group list therein, the control section 210 stores the received group list 121 in a specified folder and the like as the group list of its own.

On the other hand, if there is no difference between the group list 121 and the group list 221 (No in ACT 004), ACT 005 is skipped.

Next, the control section 210 compares the received setting information 122 with the setting information 222 (first setting information) thereof (ACT 006). The comparison refers to the comparison between the timing information in the setting information 122 and the timing information in the setting information 222. If the setting information 122 (the setting information of the master-MFP 100) is the newer one (YES in ACT 007), the control section 210 replaces the setting information 222 thereof with the setting information 122, and reflects the set value according to the description of the setting information 122 (ACT 008). The detailed operation of ACT 008 is described later. Further, if the sub-MFP 201 is newly introduced, as there is no setting information therein (or default data), the control section 210 stores the received setting information 122 in the specified folder and the like as the setting information of its own.

If the result of the determination in ACT 007 is ‘No’, the setting information 222 of the sub-MFP 201 is the newer one (Yes in ACT 009), the sub-MFP 201 notifies all the other members of setting information (ACT 010). The notification is referred to as an update notification. All the members herein refer to the MFPs registered in the group list 221 (the updated group list if the group list is updated) other than the own apparatus. The MFPs other than the own apparatus in the embodiment refer to the master-MFP 100 and the sub-MFPs 202-206. The control section 210 sends update notification to all the registered MFPs based on the group list 221.

If the result of the determination of ACT 009 is negative (No in ACT 009), the processing in the flowchart is ended. After the processing is terminated, the control section 210 deletes the group list 121 and the setting information 122 temporarily stored in the storage section 212.

Further, in a case of the master-MET 100, there are different steps with respect to the operations described above, and thus the difference therebetween is described herein. For the master-MFP 100, the processing in ACT 002 becomes an operation of acquiring the setting information and/or the group list from an external server or an external storage device (e.g. a USB memory) carried by a maintainer. If the group list is not acquired in ACT 002, as the group list 121 of its own is the latest one, ACT 003-ACT 005 can be omitted. In ACT 006, the setting information acquired in ACT 002 is compared with the setting information 122 in the master-MET 100. In ACT 008, the master-MET 100 updates the setting information 122 with the setting information acquired in ACT 002.

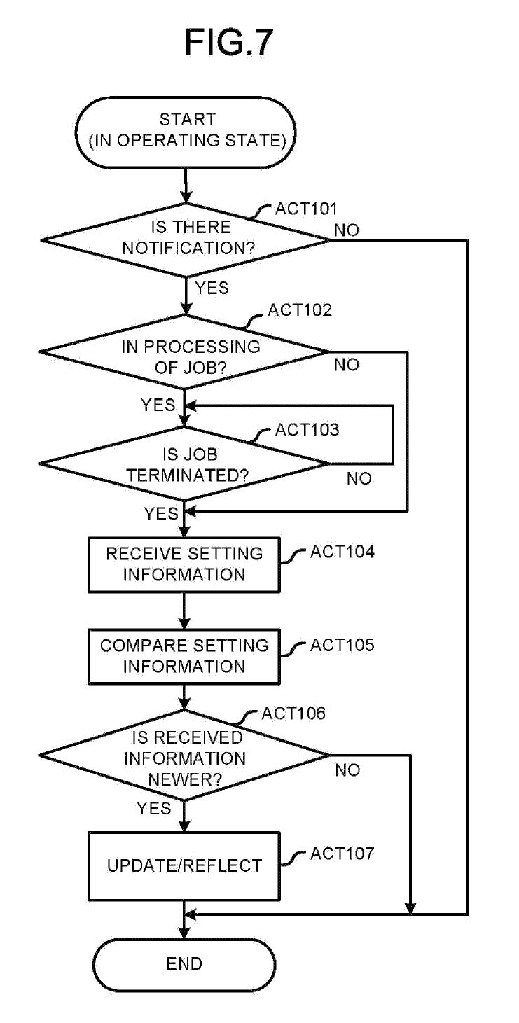

FIG. 7 is a flowchart illustrating an example of operation of the master-MFP 100 and the sub-MFPs 201-206 when receiving the update notification in an operating state. Herein, the operation of the sub-MFP 202 is described as an example, and the operations of the MFPs 100, 201 and 203-206 are the same. It is described herein that the sub-MET 202 receives the update notification from the sub-MET 201 in ACT 010 shown in the FIG. 6.

The control section 260 determines whether or not the update notification is received through the network I/F 263 (ACT 101). If the update notification is not received (No in ACT 101), the processing shown in FIG. 7 is terminated, and the sub-MET 202 returns to a standby state (returning to ACT 101). If the update notification is received (Yes in ACT 101), the control section 260 determines whether or not any of a copy job, a scanner job, a printer job and a FAX transmission/reception job is being executed (ACT 102). If there is no job which is being executed (No in ACT 102), the processing proceeds to the processing in ACT 104. If there is a job which is being executed (Yes in ACT 102), the control section 260 waits for the termination of the job (the No loop of ACT 103). Further, if there is a waiting job, the sub-MFP 202 waits for until all the waiting jobs are terminated. If the job is terminated (Yes in ACT 103), the control section 260 causes the network I/F 263 to operate to receive the setting information from the MFP which sends the update notification (ACT 104). In the present embodiment, the control section 210 of the sub-MFP 201 causes the network I/F 213 to operate to send the setting information 222, or the updated setting information 122 if the setting information 222 is updated and reflected (that is, the new update information). And the setting information 222 or the setting information 122 is received by the sub-MFP 202.

And then, the control section 260 compares the received setting information 222 with the setting information 272 thereof (ACT 105) to determine whether or not the received setting information 222 is the newer one (ACT 106). If the received setting information 222 is the newer one (Yes in ACT 106), the control section 260 replaces the setting information 272 with the received setting information 222 to update it, and then the control section 260 reflects it to enable the own apparatus to operate according to the set value of the setting information 222 (ACT 107). The update of the setting information refers to a rewrite operation on the file data in, for example, an auxiliary storage device. The reflection of the setting information refers to a rewrite operation according to the new set value in, for example, the specified area of the ROM. The set item which is not applicable to sub-MFP 202 is skipped, and only the applicable set item is reflected. That is, the control section 260 acquires the set item applicable to the own apparatus from the setting information 222, and reflects the value of acquired set item.

On the other hand, if the setting information 272 is the newer one (No in ACT 106), the processing in the flowchart is terminated.

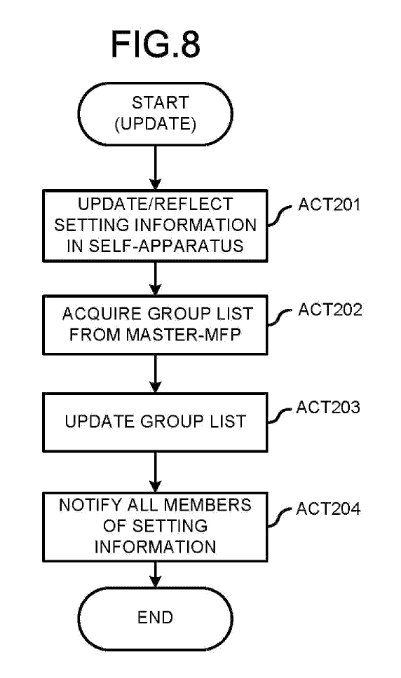

Next, the update processing of the setting information in ACT 008 is described with reference to FIG. 8. The operation in ACT 107 may be replaced by the operation shown in the FIG. 8. Herein, the operation of the sub-MFP 201 is described, and it is also applicable to the master-MFP 100, and the sub-MFPs 202-206.

The control section 210 replaces the setting information 222 thereof with the new setting information to update it, and then the control section 210 reflects it to enable the own apparatus to operate according to the new setting information (ACT 201), which is the same with the operation in ACT 107. Similarly to ACT 107, the control section 210 skips the set item which is not applicable to the own apparatus, and only reflects the applicable set item.

The control section 210 causes the network I/F 213 to operate to receive the group list 121 from the master-MFP 100 (ACT 202), and replaces the group list 221 thereof with the group list 121 to update it (ACT 203). ACTs 202 and 203 may not be executed in a case where the processing relating to the group list has been executed (in a case of executing ACT 003-ACT 005).

Similarly to the processing in ACT 010, the control section 210 notifies all the other members in the group of the update notification (ACT 204).

In the present embodiment, a case in which the function used to execute the embodiment is recorded inside the apparatus in advance is described; however, it is not limited to this. The same functions may be downloaded in the apparatus from network, or may be stored in a storage medium and then installed in the apparatus. The form of the storage medium may be optional as long as the storage medium, for example, a CD-ROM, can store the program and can be readable by the apparatus. The functions obtained by being installed or downloaded in advance may be realized with the cooperation of an OS (Operating System) in the apparatus.

Through the embodiment of the present invention, the apparatuses in the group can share the setting information and operate according to the latest setting content.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

1. An image forming apparatus belonging to a pre-defined group, comprising:
a storage section configured to store first setting information serving as setting information of the image forming apparatus;
an interface section configured to receive second setting information serving as setting information of another image forming apparatus in communication with the image forming apparatus via a network; and
a processor configured to compare the first setting information with the second setting information, and in a case where the second setting information is newer than the first setting information, configured to replace the first setting information with the second setting information to update the first setting information and to enable the image forming apparatus to operate according to the second setting information associated with the other image forming apparatus, and control the interface section to send the second setting information to one or more other image forming apparatuses belonging to the group; or in a case where the first setting information is newer setting information than the second setting information, configured to control the interface section to send the first setting information to the one or more other image forming apparatuses belonging to the group.

2. The image forming apparatus according to claim 1, wherein
the storage section further stores a first group list serving as list information of the one or more other image forming apparatuses belonging to the group; and
the processor controls the interface section to send the first setting information or the second setting information to the one or more other image forming apparatuses registered in the first group list.

3. The image forming apparatus according to claim 2, wherein
the interface section receives a second group list serving as list information of image forming apparatuses belonging to the group from a particular image forming apparatus representing the group; and
the processor compares the first group list with the second group list, and replaces the first the group list with the second group list to update the first group list if there exists difference.

4. The image forming apparatus according to claim 1, wherein
the processor determines whether the own image forming apparatus is executing a job, and if the job is being executed, the processor replaces the first setting information with the second setting information after the job is completed.

5. The image forming apparatus according to claim 1, wherein
the processor acquires a set item applicable to the image forming apparatus from the first setting information or the second setting information, and reflects the value of the acquired set item.

6. A method by an image forming apparatus belonging to a pre-defined group, including:
comparing first setting information serving as setting information of an image forming apparatus stored in a storage section with second setting information serving as setting information of another image forming apparatus in communication with the image forming apparatus via a network, wherein the second setting information is received by an interface section; and
in a case where the second setting information is newer than the first setting information, replacing the first setting information with the second setting information to update the first setting information and to enable the image forming apparatus to operate according to the second setting information associated with the other image forming apparatus,
controlling the interface section to send the second setting information to one or more other image forming apparatuses belonging to the group, or
in a case where the first setting information is newer than the second setting information, controlling the interface section to send the first setting information to the one or more other image forming apparatuses belonging to the group.

7. The method according to claim 6, further including:
storing, by the storage section, a first group list serving as list information of image forming apparatuses belonging to the group; and
controlling the interface section to send the first setting information or the second setting information to a particular image forming apparatus registered the first group list.

8. The method according to claim 7, further including:
receiving a second group list serving as list information of the image forming apparatus belonging to the group from a particular image forming apparatus representing the group; and
comparing the first group list with the second group list, and replacing the first group list with the second group list to update the first group list if there exists a difference.

9. A non-transitory machine-readable storage medium for storing a method, provided in an image forming apparatus belonging to a pre-defined group, wherein, the method for enabling image forming apparatuses to share setting information, including:
comparing first setting information serving as setting information of an image forming apparatus stored in a storage section with a second setting information serving as setting information of another image forming apparatus in communication with the image forming apparatus via a network, wherein the second setting information is received by an interface section; and
in a case where the second setting information is newer than the first setting information, replacing the first setting information with the second setting information to update the first setting information and to enable the image forming apparatus to operate according to the second setting information associated with the other image forming apparatus,
controlling the interface section to send the second setting information to one or more other image forming apparatuses belonging to the group, or
in a case where the first setting information is newer than the second setting information, controlling the interface section to send the first setting information to the one or more other image forming apparatuses belonging to the group.

10. The method in the non-transitory machine-readable storage medium according to claim 9, including
controlling the interface section to send the first setting information or the second setting information to a particular image forming apparatus which is registered in a first group list serving as list information of the image forming apparatus belonging to the group stored in the storage section.
